(19) United States
(12) Patent Application Publication
(10) Pub. No.: US 2015/0302320 A1
(43) Pub. Date: Oct. 22, 2015

(54) System, Process and Method of Booking Musicians and Artists

(71) Applicant: MUZEEK PTY LTD, New South Wales (AU)

(72) Inventors: Daniel Fiorentini, Bondi (AU); David Robledo, Bronte (AU); Todd Andrews, Surrey Hills (AU); Roel Pollers, Manly (AU)

(73) Assignee: Muzeek Pty Ltd, Bronte (AU)

(21) Appl. No.: 14/433,345

(22) PCT Filed: Oct. 15, 2013
(86) PCT No.: PCT/AU2013/001190

§ 371 Date: Apr. 2, 2015

(30) Foreign Application Priority Data
Oct. 18, 2012 (AU) 2012904560
Nov. 12, 2012 (AU) 2012904911

(51) Int. Cl. G06Q 10/02; G06Q 30/02

(52) U.S. Cl. CPC G06Q 10/02; G06Q 30/0252

(57) ABSTRACT

A system for booking a live performance by a performer using the Internet comprising the steps of: providing a booking link on the promotional website of the performer, and wherein the booking link is connected to a booking website; booking hyperlink directs a performance seeker to a webpage displaying information relating to a performer profile on the booking website, wherein performer profile includes information pertaining to performer details; the performance seeker logins into booking website using a performance seeker profile, and wherein the performance seeker profile has been verified by the website as having available funding to make offers to performer, offer is made by performance seeker to performer on a confidential chat forum on booking website, and wherein the performer and performance seeker may view each other's respective profile; performance seeker and performer agree to an electronic contract for a live performance by a performer; and performance seeker or performer records comments about the other respective party in their respective profile.

### TECHNICAL FIELD

The present invention generally relates to electronic commerce, and in particular, to an apparatus, system and/or method for booking and matching artists, performers and/or musicians; with promoters and venue operators via the internet.

### BACKGROUND

Electronic commerce has become the preferred way of completing commercial transactions. All types of products and services are being traded and purchased via the Internet using electronic commerce.

There has typically been a long felt need for an electronic commerce system that allows musicians and artists to be matched and booked with venue operators and promoters in a way that protects the financial success of both the artist and the promoter.

Previously, there have been systems of booking artists associated an online environment through websites such as www.gigmasters.com and www.chicagogigs.com. In some cases, these websites typically offer the capability to request that a performer or artist to perform. This form is then communicated to via email to performer from the promoter. The performer and promoter then correspond via email or phone calls to agree on the necessary booking details: including date, consideration, riders, price of performance and venue. These further negotiations are not typically managed or administrated by the websites and the websites take no further part in the transaction. Negotiations are typically slow and lack ease of use features.

The performer may be also risking that the promoter has the necessary skills and financial backup to facilitate the transaction. The promoter is risking that the performer is of a reliable quality and will provide the contracted service on the specified dates and times.

It has been common practice in this field, that promoters provide 50% of the total consideration for the performance in advance and the remaining 50% on completion. However, there is a still a real risk that the performer may take the initial 50% of the consideration and not provide the performance.

Previously, there have been attempts to provide online booking systems which mitigate or limit the risks of the performer or promoter. One example is described in Published PCT Application No. WO 01/22324—Snyder. This disclosure provides a system wherein a user may go to a provided website and book a performer for performance or “gig” using an automatic internet based system.

However, the system described in '324 fails to allow the performer the capability to link the booking system with their existing promotional websites such as Facebook™ or MySpace™ or other website.

This earlier system has no ratings system by which the promoters or performers can judge the relative reliability or trustworthiness of the other party.

Additionally, the funds provided as consideration for this earlier disclosed booking system are effectively locked from both parties until the performance is completed which may mean that the promoter is cash flow negative until the tickets for the performance have been sold. There is no facility for consideration that doesn't include cash such as riders or percentages of door takings.

Further, the earlier described booking system is limited as the promoters have not been independently verified as being bona fide promoters. Hypothetically, unconscionable persons could pretend to be promoters to book performers with no intention of fulfilling the booking. By using the earlier disclosed system described WO 01/22324, performers may leave themselves vulnerable to nefarious or phoney bookings.

Another previous attempt to invent and develop an online platform for booking gigs through a website has been published on http://www.gigmaven.com (Gigmaven Website). The Gigmaven Website aims to make the booking process more efficient by automating the booking process for artists and venues alike, in total decreasing the average time and cost to book a gig. Artists who wish to perform create an artist profile on this web platform and then make offers to perform at venues. If the offer is accepted, the artist is then manually contacted and booked not through an online process.

A further attempt at an online booking system for artists and venues is the Sonicbids Website (http://www.sonicbids.com). According to the Sonicbids system and Website, the artist pays for a subscription fee and then makes bid payments to perform at a venue. The bidding process is regulated by the venue and venue choses an artist to perform based on their profile and the bid. This system heavily favours the promoter or the venue and artists may be able to incur large fees through the website without successfully booking a venue, further there is no guarantee that the venue will pay the artist after the performance. The actual booking process is achieved manually after the bidding process is completed.

Any discussion of the prior art throughout the specification should in no way be considered as an admission that such prior art is widely known or forms part of common general knowledge in the field.

### SUMMARY

### Problems to be Solved

The present invention aims to provide a system, method or process that may allow performers, promoters and venue owners to negotiate booking contracts through the convenience of the website. Preferably, the venue or the artist may initiate or work the invention and the system should preferably be equally weighted in terms of negotiations between the parties.

Preferably, the invention should provide a mechanism whereby the artists, venues and promoters gain a relatively high level of trust that the performance and subsequent money transaction will be occur as agreed between the parties.

It is an object of the present invention to overcome or ameliorate at least one of the disadvantages of the prior art, or to provide a useful alternative.

### Means for Solving the Problem

A first aspect of the present invention may provide a method for booking a live performance by a performer using the Internet comprising the steps of: providing a booking link on the promotional website of the performer, and wherein the booking link is connected to a booking website; booking hyperlink directs a performance seeker to a webpage displaying information relating to a performer profile on the booking website, wherein performer profile includes information pertaining to performer details; the performance seeker logins into booking website using a performance seeker profile, and wherein the performance seeker profile has been verified by the website as having available funding to make offers to performer; offer is made by performance seeker to performer on a confidential chat forum on booking website, and wherein the performer and performance seeker may view each other's respective profile; performance seeker and performer agree to an electronic contract for a live performance by a performer; and performance seeker or performer records comments about the other respective party in their respective profile.

Preferably, said performer details include information relating to the time availability of the performer. Said webpage may be in the form of an overlayed display box shown on the promotional website. Further, the webpage may also be a lightbox.

Preferably, said comments may include a numerical rating system. Also, the method may include an additional step of comparing the available funds of the promoter to the offer and verifies that the promoter can provide the offered consideration to performer.

The offer may include any of the items from the following group: riders, cash consideration, and percentage of door takings for performance. Preferably, the method may include an additional step of the performer issuing a counter offer to performance seeker in response to the offer.

Said promotional website may be an existing website of the performer and is owned or managed by the performer. The method may also include an additional step of paying a retaining fee to owner of the booking website.

In a second aspect of the present invention, there is a provided a system for booking a live performance by a performer using the Internet comprising the steps of: providing a booking link on the promotional website of the performer, and wherein the booking link is connected to a booking website; booking hyperlink directs a performance seeker to a webpage displaying information relating to a performer profile on the booking website, wherein performer profile includes information pertaining to performer details; the performance seeker logins into booking website using a performance seeker profile, and wherein the performance seeker profile has been verified by the website as having available funding to make offers to performer; offer is made by performance seeker to performer on a confidential chat forum on booking website, and wherein the performer and performance seeker may view each other's respective profile; performance seeker and performer agree to an electronic contract for a live performance by a performer; and performance seeker or performer records comments about the other respective party in their respective profile.

Preferably, said performer details include information relating to the time availability of the performer. Said webpage may be in the form of an overlayed display box shown on the promotional website; and/or the webpage may be a lightbox.

Said comments may also include a numerical rating system. The method may include an additional step of comparing the available funds of the promoter to the offer and verifies that the promoter can provide the offered consideration to performer.

The offer may include any of the items from the following group: riders, cash consideration, and percentage of door takings for performance.

The method may also include an additional step of the performer issuing a counter offer to performance seeker in response to the offer

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

Embodiments of the present invention will now be described with reference to the drawings in which:

FIG. 1 depicts a schematic view of the a first preferred embodiment of the present invention;

FIG. 2A depicts a first flowchart of a preferred process or system to be used with or within the first preferred embodiment;

FIG. 2B depicts a second flowchart following the first flowchart depicted in FIG. 2A;

FIG. 3 depicts an example screenshot of an external website of a venue owner using part of the first preferred embodiment;

FIG. 4 depicts a first display box or lightbox overlaying the website shown in FIG. 3;

FIG. 5 depicts a second display box or lightbox overlaying the website shown in FIG. 6;

FIG. 6 depicts an example screenshot of an external website of a performer using part of the first preferred embodiment;

FIG. 7 depicts a further view of the first display box or lightbox shown in FIGS. 5 & 6;

FIG. 8 depicts a further schematic view of the process and system as part of the first preferred embodiment; and

FIG. 9 is an enlarged view of a booking button and a contact button used with or in conjunction with the first preferred embodiment.

### DESCRIPTION OF THE INVENTION

Preferred embodiments of the invention will now be described with reference to the accompanying drawings and non-limiting examples.

The following description describes a first preferred embodiment of the present invention with reference to the accompanying figures.

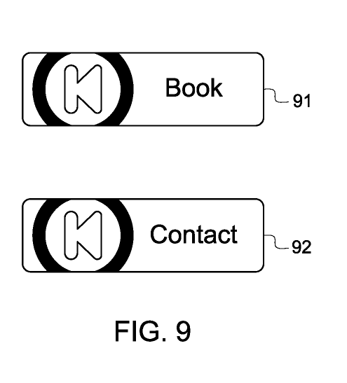

Previously, social media websites have introduced many social “buttons” to expand their platforms. These buttons aid in usability of the website and standardise inoperability between differing web enabled platforms. They have been used on Facebook™, Twitter™ and other social media websites. Accordingly, the first preferred embodiment includes a first “book” button or booking button or booking link that may be displayed and shared across the web. This book may be posted on existing webpages or websites. Preferably, the Book Button 91 is depicted as in FIG. 9. Additionally, a second alternative button is shown as a Contact Button 92.

Preferably, either button 91 or 92 may used in these embodiments of the present invention. However, the Book Button 91 is preferred for situations of positioning on the external websites of performers, whilst the Contact Button 92 is preferred for applications and positions on a venue owners or promoters external website.

Buttons are generally a convenient method of linking two website with a small logo and words that symbolise the relationship between the two different websites.

The booking button may be added to any existing first website owned or managed by a performer. Preferably, this first website includes all of the promotional material and information about the performer. The first website may include video clips, music samples or links to clips and samples. The first website may also be referred to in this specification as a promotional website.

When User 1 or Performance Seeker wants to book or hire User 2 or a Performer, the booking button may be clicked. The performance seeker may then be automatically redirected to a second website to complete a booking process with the performer. Preferably, the performance seeker will then login into the second website. In this embodiment, the second website maybe a proprietary website such as Muzeek™ website or server website. The second website may also be referred to in this specification as the booking website.

Once the Performance Seeker is logged into the second website or system, the second website may automatically display the combined calendars and information of both parties (e.g. performer and performance seeker) to either user in real time, in the same website “window,” using a pop-up display box on the computer screen of the user.

In this specification, the term “light-box” pertains to these pop-up display boxes. Additionally, the term “book” is an intrinsic music industry term, used to represent the hiring of professional performers, artists and entertainers. The term “book” has been used for decades in the music industry and is inherently the term used for hiring professional and amateur performers.

Although there have been attempts to aggregate, assimilate and/or socially “connect” employers and employees within the music industry, all transactions, negotiations and interactions are done within email or other messaging platforms including, but not limited to, social networks such as Facebook and Twitter.

The process or system allows or is adapted to allow for offers to be sent directly (in real time) to each party within the music industry by combining publicly displayed calendars and information, giving each user the ability to virtually “book” an employee by choosing a mutually available date, offering a price and sending a message all in a single process within our platform. That information is then integrated within both user's accounts once signed into described system. Both users have agreed to display their information publicly, which allows our system to combine both digital calendars and offer a more convenient, efficient and effective method of primarily connecting employers and employees.

Users can communicate and connect with each other by interacting with “element 1,” having never visited muzeek.com on their web browser, as our “element 1” connects automatically with our host website. Subsequently, all of the User's information is accessed and displayed, once logged in, through the preferred “lightbox” when “element 1” is clicked on any website across the Internet. Any offers or negotiation is then automatically forwarded and implemented into the user's database.

An electronic booking request is transmitted for a request to book the performer displaying the unique book “button,” which is expressed above. The electronic booking request includes dates, offering fee and the imbedded information of the requesting user, as the requesting user is signed into the system and publicly displays their information. The electronic request is transmitted to the performer for consideration of the request, which can be accepted, declined or negotiated further, and additional information can be provided via an internal chat mechanism within server's database.

The Element 1 book “button” can be placed and displayed anywhere on the internet, allowing each user to interact from virtually any digital interface. The serving provider of the button is hosted through code.

The first preferred embodiment may combine or incorporate two primary elements (hereinafter “element 1” and “element 2”) to create a digital method, process or system for booking or hiring performers in the music and entertainment industry. This preferred embodiment combines digital calendars and relevant information of performance seekers and performers in the music industry, through a socially interconnected, digital “book” button which can be placed anywhere on the web.

Element 1—“Digital Book Button”

The first element (“element 1”) of the first preferred embodiment is a socially interconnecting, open-sourced API platform button used on music industry related websites, social network profiles and music media websites that allows employers to “book” or “hire” employees within the music industry. This includes, but is not limited to, artists, musicians, performers, event producers, event planners, venues, property managers, music labels, sponsors, festival owners and promoters. This “element 1” book button can be implemented and shared all over the web using our open-source, unique HTML code that can be embedded on any website, which connects User 1 to User 2 automatically once pressed.

The hosting source of the inventive book button is muzeek.com using open-source API coding which directs information back to our website database, however, all interaction may take place on external sites with the use of our book button “light-box” which will appear above the external site in which the button is placed.

Element 2—“Digital Collaborative Calendar Coordination”

The second element (“element 2”) of the first preferred embodiment is the digital method of calendar and scheduling collaboration, in which the distinct and unique information between two users, provided to our system by users, is preferably automatically combined into one viewable and consolidated calendar upon the click of the booking button (when the users are logged in). The information is then transmitted and integrated permanently within our platform to provide each user the data, in real time, that can be accessed in their unique accounts within Muzeek™. Preferably, both users may then be able to message, negotiate, offer, counteroffer and manipulate this information to reach an agreement of business. User 1 seeks to “book” or “hire” User 2 and, upon clicking the booking button, instantly sees the availability and information of both users on a “combined calendar” that displays the public information of each user in a light-box upon the same website User 1 was browsing.

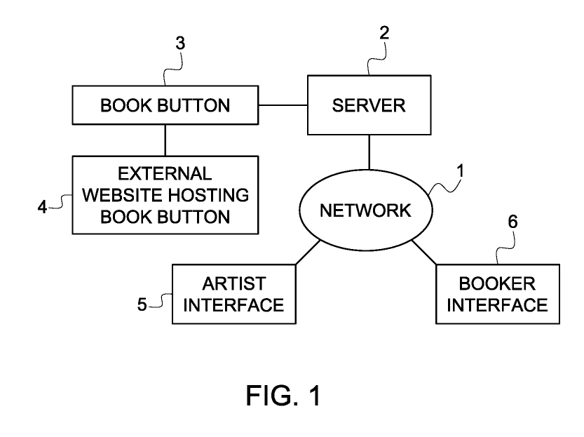

FIG. 1 of the accompanying drawings depicts the basic schematic concept of the preferred booking system and/or method forming part of or to be used with the first preferred embodiment of the present invention.

A Book Button 3 or booking is inserted into a promotional website depicted in FIG. 1 as an external website 4. The booking link connects to a server 2. Preferably this is the server 2 computer running a database behind the second website or the booking website. The server 2 includes a series of profiles of various users. The users include: performers and performance seekers. Preferably, the profiles include information relating to: timing or calendar availability, picture or photo of user, user name, user address details, user verification details, minimum fee for performance (if relevant), comments from third party users, and ratings of user by third parties.

The Artist Interface 5 or performer interface always the performer to verify the details of the performance seeker and send messages to performance seeker in real time. Preferably, this accomplishes using on an online chat system in a private channel. The performer interface allows the performer to comments and ratings posted by other performers about the performance seeker. In this way, the performer can verify whether the performance seeker has a relatively good reputation.

The Booker Interface 6 or performance seeker interface works in a similar manner to the performer interface. However, the performance seeker will be allow to see details, comments and ratings about the performer posted by other performance seekers. This may allow the performance seeker to determine the trustfulness and reliability of the performer. The ratings may include a numerical star rating based system wherein users are rated from one to five stars, wherein one star is the lowest and five stars is the highest.

The network icon depicted in FIG. 1 is the internet which facilitates the users to interact with the server through their respective interfaces.

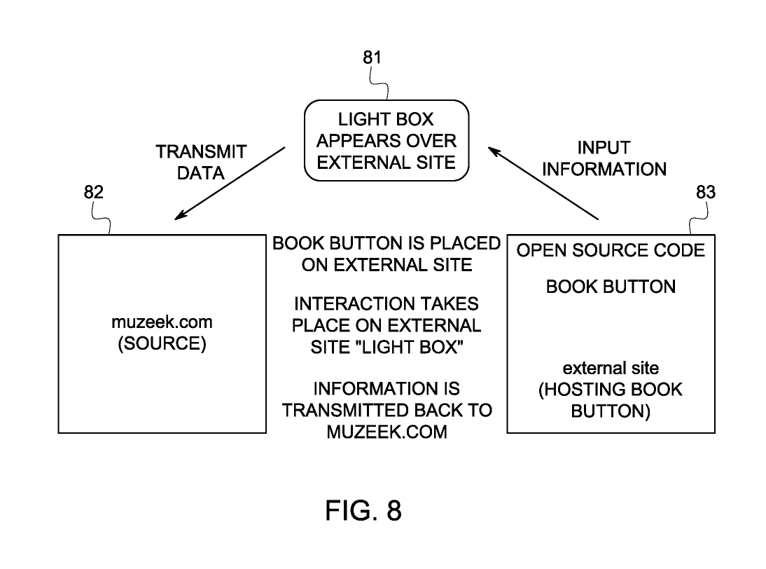

FIG. 8 schematically shows the preferred system or process in greater detail. The external site 83 or promotional website is depicted to include the Book Button 91 or 3. The activation of the Book Button leads to a display box being overlayed onto the promotional website as a pop-up box called a “lightbox” 81. The Lightbox 81 interacts with the booking server 82 denoted as “muzeek.com (Source). This booking server 82 serves the same function as the server depicted in FIG. 1.

The advantage of the process or system shown in FIG. 8 is that the user is removed or taken away from the promotional site. The booking button has activated a lightbox and displays the necessary information in the lightbox and the integration of the booking system with the performer's regular promotional website is relatively seamless.

Additionally, most interaction between the users is conducted through the use of lightboxes and the users are not required to independently go to a third party website to book the performer.

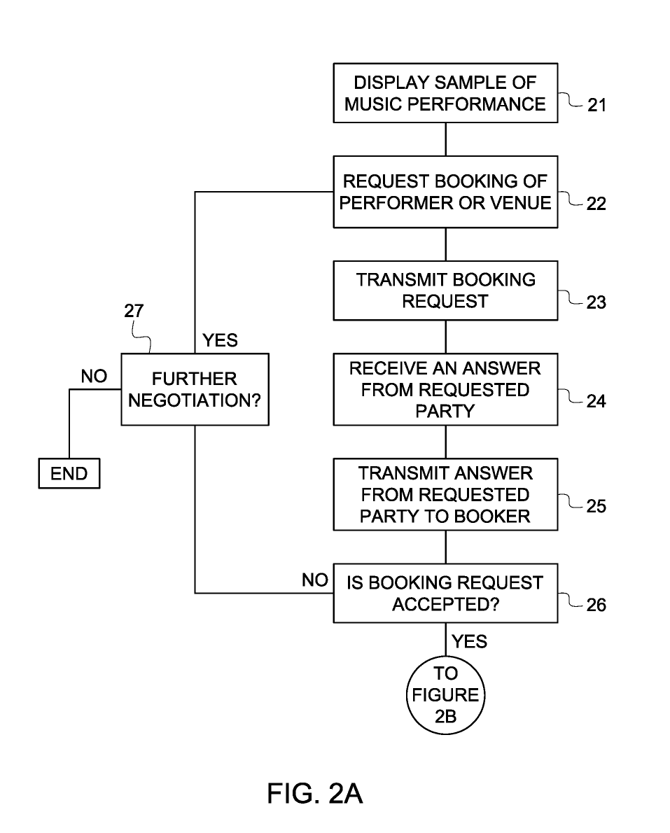

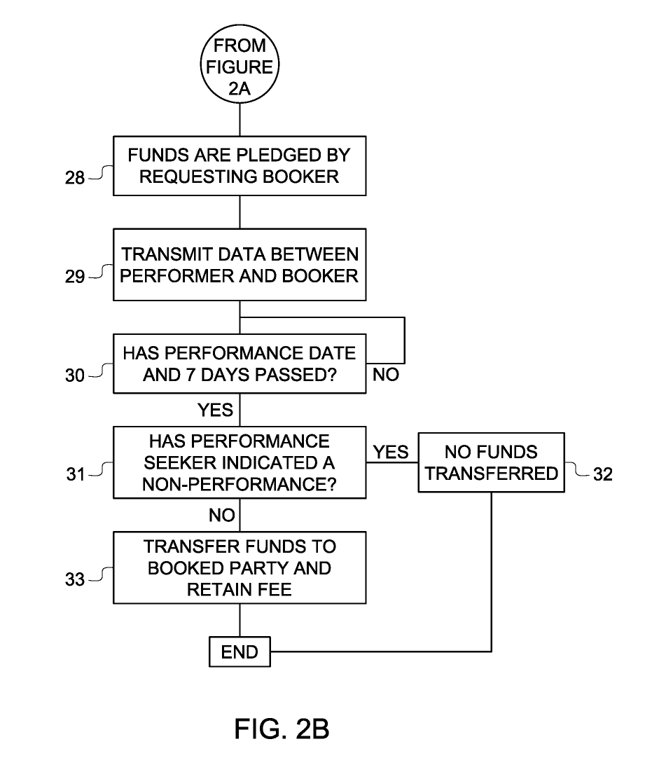

FIGS. 2A and 2B show the preferred booking system, method or process that forms part of the first preferred embodiment of the present invention. The process starts in FIG. 2A, wherein a performance seeker sees or listens to a musical performance appearing on the promotional website of the performer, depicted as Step 21. The performance seeker clicks on the booking link or button. Step 23 occurs through a request for a booking is sent via the aforementioned server to the performer. The booking request (step 23) includes an offer of payment and the preferred time of performance. The performance seeker may be able to visually verify the availability of the performer in an online calendar system.

The performer then transmits an answer (step 24) to the performance seeker (or booker as labelled in FIG. 2A). If the booking is accepted the process continues to FIG. 2B otherwise the process redirects the users to a counteroffer system (step 25) which is negotiated via a private chat channel on the booking website. The system repeats until there is no further negotiation or an agreement is reached (step 27).

Additionally, the process shown in FIG. 2A may include an option for for the person booking the performer to click on a Play Button (not shown) on the lightbox to allow for the playback of a recorded sample of the performer or artists work. This may further extended to include: audio clips, video clips or photographs. This step may be optional as the samples of the performance may be available from the promotional website.

Once agreement is reached, the process continues as per the flowchart shown in FIG. 2B. The consideration for the agreement is pledged (step 28) by the performance seeker or broker. The consideration may include: cash payments, percentage of door takings, or other riders which are common to the music or performing industries.

Data is transmitted between the respective users confirming performance dates and consideration and other necessary details (step 29). The performance seeker then confirms whether the performance has taken place after the event. If the performance proceeded on the correct time, the consideration to transferred by the performance seeker to the performer and a retaining fee is charged by the manager of the second website as a commission (steps 29 to 31). If the performance did not proceed on the correct date, no consideration is transferred between the parties (step 32).

Preferably during this system and process, the performance seeker and performer may be logged into the second website using cookies or similar technology to track their activity and record their respective comments and feedback.

After the transaction shown in FIGS. 2A and 2B is completed the respective parties may record comments, feedback and ratings about the other party and this information is recorded in the respective profiles of the parties. This step allows for a significant advantage in that future parties contracting with the performance seeker or the performer will know their transactional history and will be able to instantaneously review whether they are trustworthy and reliable.

Further, the system and process of the first preferred embodiment of the present invention also includes a verification system for the performance seeker. Typically, when a user requests to be registered as a new performer seeker, they will be require to adequately demonstrate that they are a bona fide performance seeker. Generally, the system will request from them information demonstrating that they are a bona fide operator and this information will be independently verified by a human operator controlling the booking website prior to permission for the performance seeker to use the system. The main reason and advantage for this feature is that it allows the performers some level of certainty that the performance seeker is at least capable of demonstrating a basic level of bona fide operations.

The system or process may also automatically request that the performer seeker provide funding or banking details to demonstrate that they have the facilities to provide payment to the performer on completion of the performance.

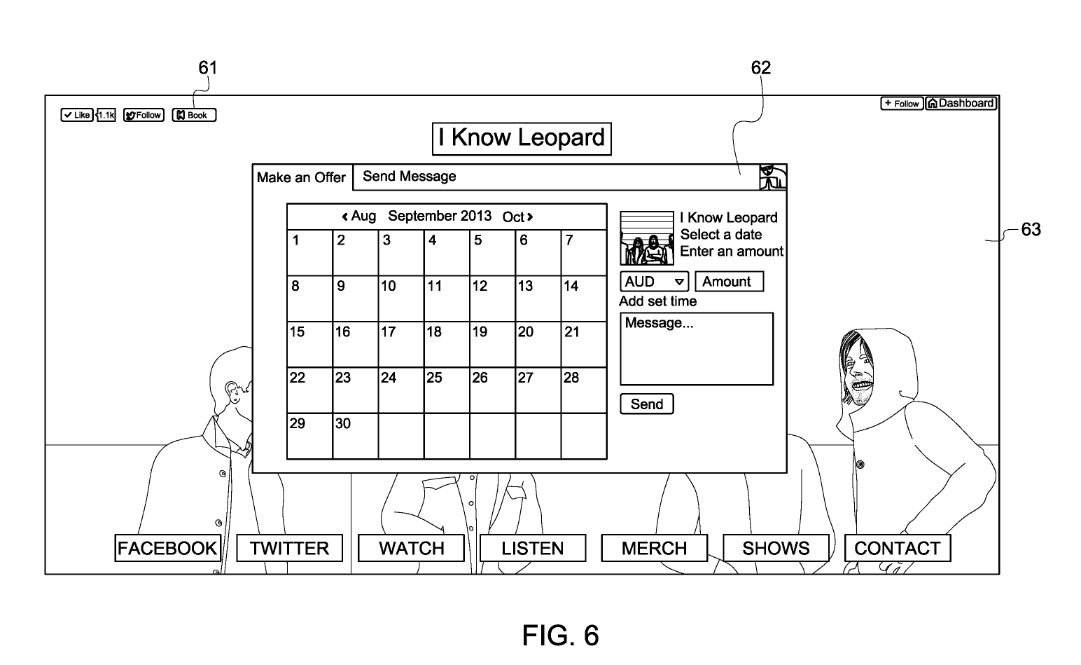

FIG. 6 depicts a sample of a promotional external website of a performer wherein the website includes a Book Button 61 or booking link, which is depicted in greater detail in FIG. 9. Preferably, the Book Button 61 is presented or displayed beneath the depicted album cover artwork, but other positioned are possible. Specifically, in FIG. 6, the Book Button is depicted as being positioned at the top of the webpage adjacent to social media buttons. Preferably, the Book Button is an open-sourced API communicative button that directly integrates and accesses information to and from the booking website located at http://www.muzeek.com.

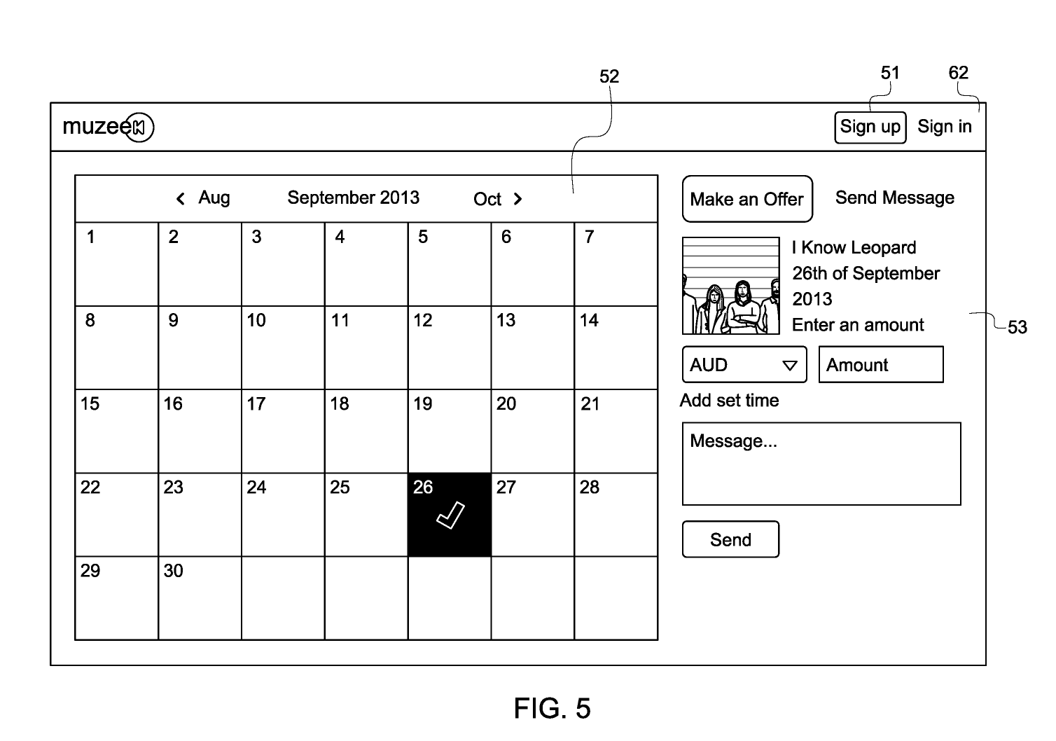

The effect of activating the Book Button 91 as shown in FIG. 6 is that a lightbox 62 pops up on screen and overlays the original external website of the performer. It is noted during this example screenshot of the user interface, the user is logged in. This figure, the user is a performance seeker. Enlarged images of the lightbox 62 are depicted in FIGS. 5 & 7.

If performance seeker is logged in and clicks the booking button, lightbox 62 displays “element 2” combined communicative calendar collaboration which displays all public “availability” between both users in real time. User is interacting upon external website and is not redirected to the full version of the muzeek.com source website, nor is additional website “tabs” or “windows” necessary for interaction.

Preferably, the lightbox 62 may also display an “offer” from the performance seeker to performer. The offer may typically include cash consideration in the provided box. However the parties could also agree to other forms of consideration. Additionally, the lightbox 62 allows the user to see available time and dates for booking in the calendar section 52 and the light box also allows them to make offers based on a particular available time or date through the contact form section 53.

Preferably, the amount of consideration is in relative legal currency and a “message” box which is sent directly to User 2's interface within the booking website such as http://www.muzeek.com.

FIG. 5 depicts an enlarged view of the lightbox 62, as above described. The availability calendar depicts the dates and times that the performer is available to be booked. In FIG. 5, the user can see the name of the performer (in this example “I Know Leopard”), the performer location (in this example, “NSW, Australia”) and Style or genre of performance (in this example “Indie”).

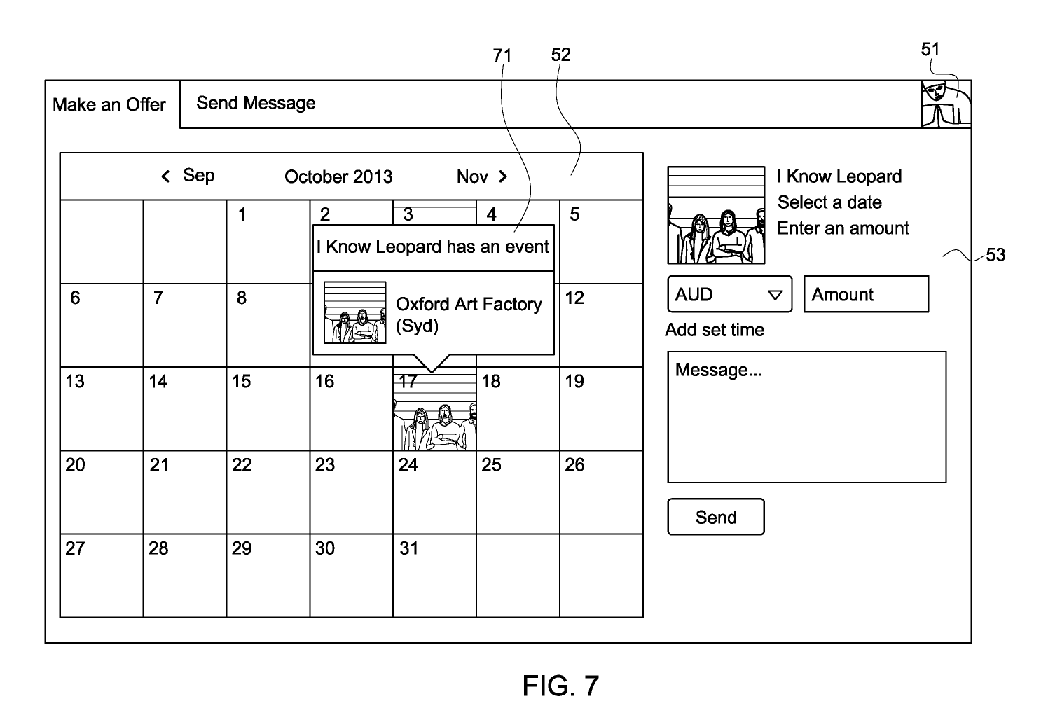

FIG. 7 depicts a lightbox 62 as shown by the system or process of the first preferred embodiment, wherein the user is logged into the system. The lightbox 62 gives the users an opportunity to enter their login details or contact the booking website to request a login via the login section 51. The process of registration and logging in a particular use is the same as traditional use by other websites which is relatively well known. Preferably, users need to be logged in the booking website to use the process or system and the login details and matched with the users respective profiles to derive booking information and calendar information.

In FIG. 7, the booking is shown at the designated time and date as being booked and this record serves as a confirmation for both the performer and performance seeker.

Additionally, when a mouse pointer is directed pre-booked times and dates appearing on the calendar, the user can see where and when the performer has other bookings through the system. FIG. 7 shows the effect of pointing the mouse pointer to specific pre-booked time and dates. In this example, it shows a further pop-up box wherein the sample performer “I Know Leopard” has performances booked at “Oxford Art Factory”.

FIG. 7, further depicts “Element 2” which may include a combined calendar close-up of displayed information and functionality including collaborative data that displays information from both users including “availability” and relevant information about existing bookings. This data displays the combined information from the hosting user displaying “element 1” as well as the inquiring user whom actually clicks “element 1.”

The preferred platform technology included within the first preferred embodiment of the present invention may automatically aggregates and gathers both user's data in real-time, displaying all relevant information necessary to “offer” a booking according to such data. No other data from the external website is accessed from either user.

In this specification, external websites refer to the original websites of performers, artists, venue owners, performance seekers and promoters, which are external to the source server or source website.

1. An open-source API, HTML-encoded “book” button (“element 1”) which includes the word “book” as an inherently used music industry term for hiring for live performances and events. This button can be displayed on any website, application or service across the Internet and directly ingrates and accesses information from user accounts within muzeek.com. “Element 1” retains the name “book” on it's interface as inherent term used widely in the entertainment industry for hiring. The open source API, HTML-encoded “book” button may be replaced with a equivalent link button written in any coding system that is used to interact with the Internet or internet browsers.

2. Digital, collaborative calendar coordination (“element 2”) which uniquely combines multiple user's public information inputted into muzeek.com, which is displayed in light-box form on external websites as well as displayed internally on and within muzeek.com.

This information includes, but is not limited to, entity name, location, date availability in calendar form, future bookings, previous bookings, current bookings, minimum booking offers in relative legal tender and other publicly displayed data made available within muzeek.com. User 1 can then make and send an “offer” to User 2 within “element 2” and the offer information is sent directly to “User 2” in multiple forms including email, respective user profiles or push notifications on a mobile device. The information updates in real time and all accessed and modified information is then integrated and assimilated into each user's existing database within the booking website (for example http://www.muzeek.com).

Preferably, the system and process described in respect of the first preferred embodiment aims to provide an improved booking system for live performances using the internet. The system and process may achieve increased interoperability with existing internet architecture and websites in way that has been previously described in relation to other systems.

Further to the first preferred embodiment of the present invention, the process or system described may be implemented on an internet enabled computer apparatus, wherein the previously described server is adapted to run the described processes and systems to facilitate all steps and transactions of the process in an online environment.

Preferably, the book button or booking link may be also provided to or incorporated into the coding for other promotional websites not just for performers but also the existing websites of performance seekers. For example, a promoter may include the booking button on their website and allow performers to request a gig or performance at their venue or event. The promoter and performer would come to an agreement based on the same system as described in the first preferred embodiment of the present invention.

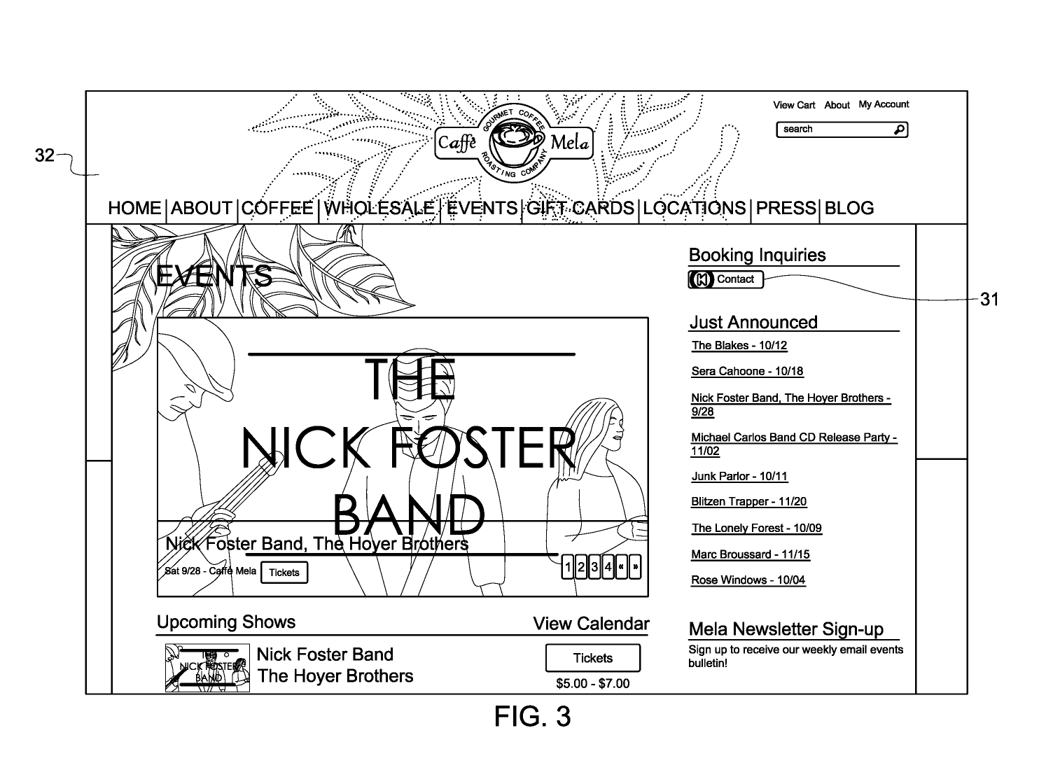

Further, the Book Button 91 may be replaced with a Contact Button 92 as depicted in FIG. 9. The Contact Button is more suited to placement on the external websites of performance seekers. In FIG. 3, the use of the Contact Button 92 is demonstrated at position 31 on a example Venue Owner's external website 32. In this example, the external venue owner is a location called “Caffe Mela”.

In this case, a performer may click on the Contact Button 92 and a lightbox pops up and overlays the external website in a similar manner to the previous example shown and described with reference to FIGS. 5, 6 & 7. The main difference is that the displayed information is now relevant to the Venue Owners and the Performer may make an offer following the similar steps to the process depicted in FIGS. 2A and 2B.

However, the roles in the process are inverted to allow for the performer to make the offer.

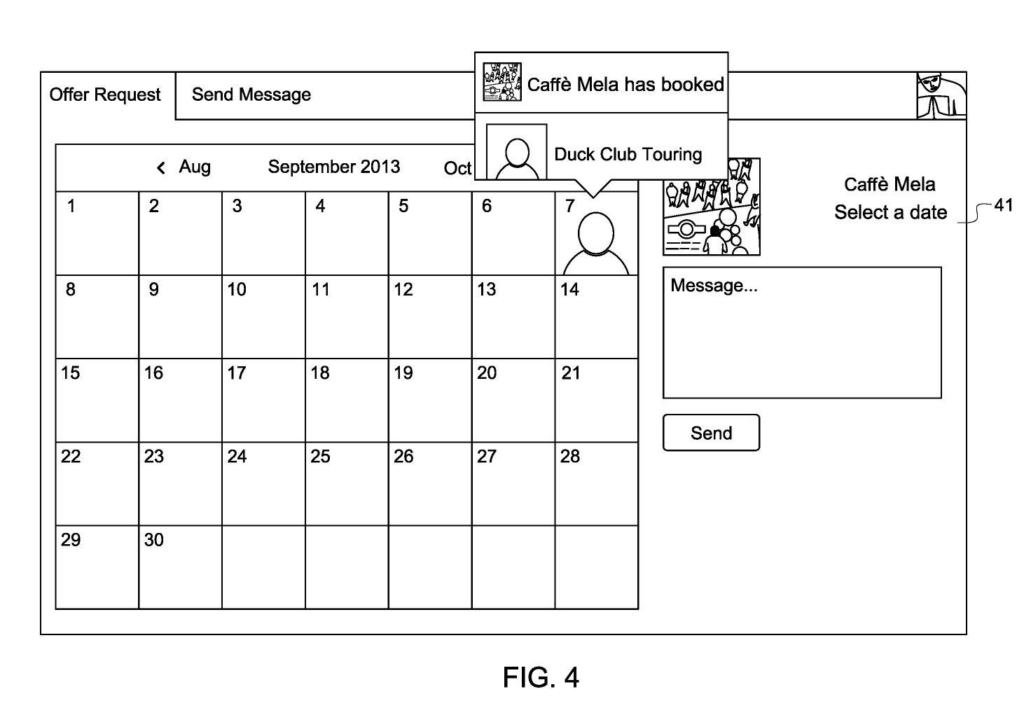

The information displayed in the lightbox 41 in FIG. 4 is very similar to FIGS. 5 & 6 but the calendar section is relevant to the availability of the venue and the offer is made by a chat protocol or interface.

In these circumstances the role of the promoter and the performer are reversed in terms of offer and acceptance. The performer makes an offer to the promoter and the promoter makes a decision whether to proceed, reject or counter offer.

For purposes of this specification, the term “performer” includes within its meaning: any person advertising their services in relation to providing live performances, artist, and/or musician.

The term “performance seeker” includes within its meaning: any person seeking to book a performer for a live performance, promoter, venue operators, event producers, event planners, property managers, music labels, sponsors, festival owners and promoters.

The term “lightbox” as used in this specification may also include within its meaning the use of modal boxes which is commonly described in this field of art.

It is the intention that terms relating to a person referred to in the singular may also be applied in the persons in a plural context.

In a further embodiment, the booking link described in respect of the aforementioned embodiments may additionally take the form of an embedded calendar link or roster. The calendar link may be a graphical representation of the availability of an artists or venue. The calendar link may be in a form that is similar the calendar or roster depicted in FIG. 4, 5, 6 or 7.

Preferably, the calendar link may show the available dates for bookings. However the calendar link would be preferably as small as possible to reduce screen real estate whilst maintain readability.

Various additional modifications and variations are possible within the scope of the foregoing specification and accompanying drawings without departing from the scope of the invention

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

The claims defining the invention are as follows:

1. A method for booking a live performance by a performer using the Internet comprising the steps of:
a. Providing a booking link on the promotional website of the performer, and wherein the booking link is connected to a booking website;
b. Booking hyperlink directs a performance seeker to a webpage displaying information relating to a performer profile on the booking website, wherein performer profile includes information pertaining to performer details;
c. The performance seeker logins into booking website using a performance seeker profile, and wherein the performance seeker profile has been verified by the website as having available funding to make offers to performer;
d. Offer is made by performance seeker to performer on a confidential chat forum on booking website, and wherein the performer and performance seeker may view each other's respective profile;
e. Performance seeker and performer agree to an electronic contract for a live performance by a performer; and
f. Performance seeker or performer records comments about the other respective party in their respective profile.

2. The method of claim 1, wherein said performer details include information relating to the time availability of the performer.

3. The method of claim 2, wherein said webpage is in the form of an overlayed display box shown on the promotional website.

4. The method of claim 3, wherein the webpage is a modal box.

5. The method of claim 4, wherein said comments include a numerical rating system.

6. The method of claim 5, wherein the method includes an additional step of comparing the available funds of the promoter to the offer and verifies that the promoter can provide the offered consideration to performer.

7. The method of claim 6, wherein the offer includes any of the items from the following group: riders, cash consideration, and percentage of door takings for performance.

8. The method of claim 7, wherein the method includes an additional step of the performer issuing a counter offer to performance seeker in response to the offer.

9. The method of claim 8, wherein said promotional website is an existing website of the performer and is owned or managed by the performer.

10. The method of claim 9, wherein the method includes an additional step of paying a retaining fee to owner of the booking website.

11. A system for booking a live performance by a performer using the Internet comprising the steps of:
a. Providing a booking link on the promotional website of the performer, and wherein the booking link is connected to a booking website;
b. Booking hyperlink directs a performance seeker to a webpage displaying information relating to a performer profile on the booking website, wherein performer profile includes information pertaining to performer details;
c. The performance seeker logins into booking website using a performance seeker profile, and wherein the performance seeker profile has been verified by the website as having available funding to make offers to performer;
d. Offer is made by performance seeker to performer on a confidential chat forum on booking website, and wherein the performer and performance seeker may view each other's respective profile;
e. Performance seeker and performer agree to an electronic contract for a live performance by a performer; and
f. Performance seeker or performer records comments about the other respective party in their respective profile.

12. The system of claim 11, wherein said performer details include information relating to the time availability of the performer.

13. The system of claim 12, wherein said webpage is in the form of an overlayed display box shown on the promotional website.

14. The system of claim 13, wherein the webpage is a modal box.

15. The system of claim 14, wherein said comments include a numerical rating system.

16. The system of claim 15, wherein the method includes an additional step of comparing the available funds of the promoter to the offer and verifies that the promoter can provide the offered consideration to performer.

17. The system of claim 16, wherein the offer includes any of the items from the following group: riders, cash consideration, and percentage of door takings for performance.

18. The system of claim 17, wherein the method includes an additional step of the performer issuing a counter offer to performance seeker in response to the offer.

19. The system of claim 18, wherein said promotional website is an existing website of the performer and is owned or managed by the performer.

20. The system of claim 19, wherein the method includes an additional step of paying a retaining fee to owner of the booking website.

21. A method for booking a live performance at a venue or event using the Internet comprising the steps of:
a. Providing a booking link on the promotional website of the promoter, and wherein the booking link is connected to a booking website;
b. Booking hyperlink directs a performer to a webpage displaying information relating to a promoter on the booking website, wherein promoter profile includes information pertaining to promoter details;
c. The performer logins into booking website using a performer profile, and wherein the performer profile has been verified by the website as having available funding to make offers to performer;
d. Offer is made by performer to promoter on a confidential chat forum on booking website, and wherein the performer and performance seeker may view each other's respective profile;
e. Performance seeker and performer agree to an electronic contract for a live performance by a performer; and
f. Performance seeker or performer records comments about the other respective party in their respective profile.
